(19) United States
(12) Patent Application Publication
(10) Pub. No.: US 2004/0200914 A1
(43) Pub. Date: Oct. 14, 2004

(54) Load display device for crusher

(75) Inventors: Tooru Hishiyama, Hirakata-shi (JP); Toshio Kitani, Hirakata-shi (JP); Eiichi Muramoto, Hirakata-shi (JP); Takuya Uemura, Hirakata-shi (JP); Kazuyuki Yamazaki, Hirakata-shi (JP); Shimpei Abe, Hirakata-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/805,617

(22) Filed: Mar. 18, 2004

(30) Foreign Application Priority Data
Apr. 9, 2003 (JP) 2003-104791
Aug. 27, 2003 (JP) 2003-302399

(51) Int. Cl. B02C 21/02

(52) U.S. Cl. 241/101.74

(57) ABSTRACT

A load display device for a crusher, which is capable of efficiently performing crushing work by making an operator recognize a load condition, is provided. For this purpose, the load display device for the crusher, which displays the load condition at a crushing section in the crusher, includes a monitor (30) provided at a location which the operator is able to recognize visually, and a screen (31) which is provided on the monitor (30) and graphically displays a condition of a load at a crushing section (4A).

### TECHNICAL FIELD

The present invention relates to a load display device for a crusher, which is used for crushing objects to be crushed such as industrial wastes, stones and rocks, and the other massive and/or long objects.

### BACKGROUND ART

As for a crushing apparatus (crusher) for crushing objects to be crushed, there are conventionally mobile types (a towed type, a self-propelled type and the like) in addition to stationary types. For example, as for a self-propelled crusher, a biaxial shearing type crushing apparatus including a hopper into which objects to be crushed are charged at a position of an end portion at one side (hereinafter, called a rear side) in a longitudinal direction of a vehicle body frame, is loaded on a top portion of the vehicle body frame including a carrier. A power source such as an engine, which is disposed in series with the aforesaid crushing apparatus, is loaded at a position of an end portion at the other side (hereinafter, called a front side) in the longitudinal direction of the vehicle body frame. Further, a Conveyor for transferring crushed objects subjected to the crushing processing is provided from the position under the aforesaid crushing apparatus toward the front. A magnetic separator is additionally provided at an upper portion midway of conveyor so as to be able to select and remove metal included in the nonmetallic crushed objects such as house dismantling wastes.

In the crusher as described above, an operation method, in which an operator gets on, for example, a loader or the like for mainly loading objects to be processed (objects to be crushed) to perform an operation by a remote control, and directly charges the objects to be processed into the biaxial shearing type crushing apparatus from above the hopper, is adopted. On charging the objects to be processed, the operator adjusts a charging amount based on the experience under present circumstances. Since the operator mainly grasps the charging amount by visual measurement or the like, and the charging amount varies considerably depending on the shape and the quality of the objects to be processed which the operator deals with, the crusher is easily under excessive load, and a skill is demanded.

It gives the operator a large burden to operate the crushing apparatus by depending on the skill of the operator so that the load on the crushing apparatus is not excessive, and it causes the problem that once the operator makes a mistake in visual measurement, the object to be crushed are clogged in a crushing section, which makes it impossible to continue a normal operation, and much time is spent on repair such as removal of the clogged crushed object and the like to reduce workability seriously. Thus, as a prior art to solve such a problem, Japanese Patent No. 2628054 is known. According to Japanese Patent No. 2628054, in a crushing apparatus for rocks and stones, a television camera is placed at a crushing section to recognize the condition of the crushing section visually by a screen image, and a controller for controlling a transfer speed of a rough stone by an object to be crushed supplying conveyor for supplying the objects to be crushed to the crushing section is provided. This is the method of controlling the transfer speed of the aforesaid object to be crushed supplying conveyor to be optimal from an operator's cab of a loader while the operator visually recognizes the condition of the crushing section by a television monitor by making it possible to receive an image taken by the aforesaid television camera in the television monitor at the cab seat of the loading vehicle in which the operator is riding.

### SUMMARY OF THE INVENTION

However, in the art known by the aforesaid Japanese Patent No. 2628054, the operator determines the condition of the crushing section by seeing the screen image taken by the television camera. Accordingly, though it is considered that the operator can concretely grasp the condition, the operator does not directly detect the load at the crushing section, but the operator only sees the bulk of the objects to be crushed which are transferred by the supply conveyor, and the operator does not know the change in a crushing force according to the hardness and the like of the objects to be crushed. Consequently, this becomes the indirect detection of the load, which depends on the ability of the operator, and if the operator tries to perform the control normally, a sense of fatigue is enhanced, which is not preferable for mental health. Further, skill is demanded of the control, and if the control is not favorably performed, the crushing apparatus is sometimes under excessive load and has to be stop operation, which requires time for repair, thus causing the problem that the operation efficiency is reduced or the like. Further, there exists the problem that much dust occurs to make it difficult to see the screen image.

For example, in a crushing apparatus for performing crushing processing of industrial wastes and the like, the objects in various shapes and forms are dismantled and crushed as the objects to be processed that arc handled there are metallic products, house dismantling wastes, straw matting, and automobile tires. In contrast to the metallic products (mainly the cases of home electric appliances. waste bicycles, and the like), and the house dismantling wastes (mainly wood products), as to the objects to be processed which is difficult to cut such as straw matting and automobile tires which are soft, with long fibers, and high in tenacity, it is not easy to determine the load at the crushing section at their processing time in accordance with the charging amount or the bulk of the objects to be processed. Consequently, if the operation is mistakenly performed, the phenomenon that the objects to be crushed is caught in the crushing section, or clogged in the peripheral portion occurs, and excessive load occurs to make the operation difficult, and much time is spent on repair. Accordingly, it is necessary for the operator to adjust the charging amount while determining the condition at the time of processing based on the experience without depending on the visual recognition, and there arises the problem that the skill in the operation for operating the crushing apparatus is demanded.

The present invention is made to solve the problems as above, and has its object to provide a load display device for a crusher capable of performing a crushing work efficiently by making an operator directly recognize a load condition by displaying a load at a crushing section.

In order to attain the aforementioned object, the load display device for the crusher according to the present invention is a load display device for displaying a load condition at a crushing section, and comprises a monitor provided at a location which an operator is able to recognize visually, and a screen which is provided on the monitor and graphically displays a condition of a load at the crushing section.

According to the above constitution, the load condition at the crushing section is graphically displayed on the screen of the monitor, so that the operator can determine the present condition of the load by seeing the screen. By doing so, the actual load condition can be determined, and by estimating the progress, the next charge of the objects to be processed into the crushing section can be reasonably performed, thus making it possible to perform a smooth operation continuously.

It is preferable that load display made on the screen is level display which relates to magnitude of the load at a driving section for driving the crushing section and is made with an allowable load as a maximum. According to this constitution, the operator can estimate the change of load, and can realize prevention of excessive load and prevention of stop of the operation, which is useful in enhancing the operation efficiency.

It is preferable that level display is made corresponding to a selected object to be processed. Alternatively, the load display is made corresponding to a selected object to be processed, on a load display part of the screen. According to the constitutions, load display corresponding to the various kinds of objects to be processed is made during crushing, and there is the advantage of making it possible to perform operation in the state in which excessive load is not caused.

Further, it is preferable that a frequency of excessive load within a predetermined time at the crushing section and a number of changes of a rotating direction of the crushing section within a predetermined time are displayed as additional load display. According to this constitution, on the occasion of crushing processing of the objects to be processed which are not easy to crush, at the time of occurrence of excessive load, the excessive load is released by reversely rotating the crushing means, and it is easily determined whether the operation is continued by the reverse rotation within a predetermined time or the operation is stopped to perform check, or the like. Since the situation of the progress is graphically displayed, and can be determined without always watching it, the situation of the progress is easily seen and fatigue is not felt, thus facilitating the operation for operating the crushing apparatus, and remarkably enhancing workability.

### BRIEF DESCRIPTION OF THE DRAWINGS

FIG. 1 is a side view of a self-propelled biaxial shearing type crusher according to an embodiment of the present invention;

FIG. 2 is a plan view of FIG. 1;

FIG. 3 is a view showing a panel surface of an operating panel including a load display monitor according to an embodiment;

FIG. 4 is a view showing an outer shape of the load display monitor according to the embodiment;

FIG. 5A and FIG. 5B are screens in the load display monitor according to the embodiment, FIG. 5A is a screen for selection of a mode according to objects to be crushed, and FIG. 5B is a display screen at the time of working;

FIG. 6A and FIG. 6B show screens in the load display monitor according to the embodiment, FIG. 6A shows a screen of a straw matting mode, and FIG. 6B shows a screen of a pallet mode;

FIG. 7A to FIG. 7D are views of screens showing load conditions in the pallet mode, according to the embodiment, FIG. 7A is a working mode screen under light load, FIG. 7B is a working mode screen under heavy load, FIG. 7C is a working mode screen under maximum load, and FIG. 7D is a load display screen under maximum load.

FIG. 8A to FIG. 8C are views of screens displaying the load display part by enlarging it, according to the embodiment, and show the change in the number of excessive loads, FIG. 8A is a case in which the number of excessive loads is one. FIG. 8B is a case in which the number of excessive loads is two, and FIG. 8C is a case in which the number of excessive loads is three.

### BEST MODE FOR CARRYING OUT THE INVENTION

A concrete embodiment of a load display device for a crusher according to the present invention will be explained with reference to the drawings.

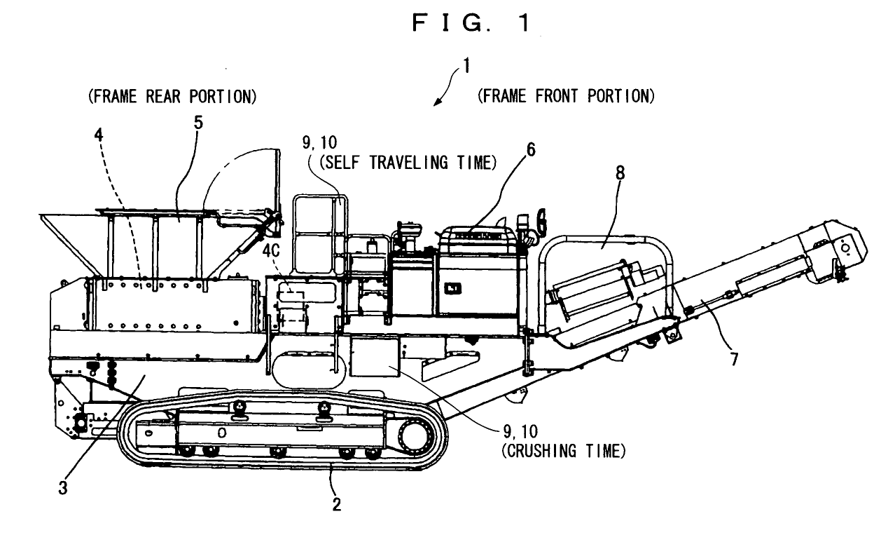

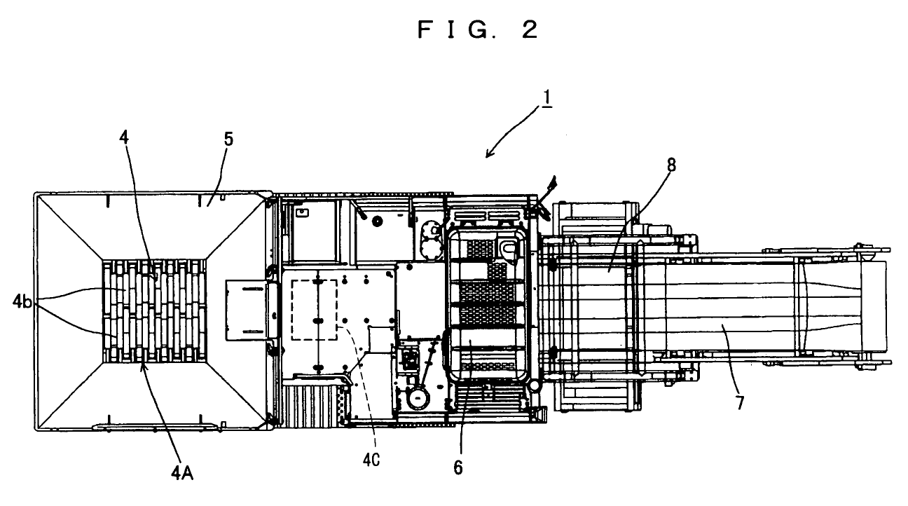

The explanation will be made with use of FIG. 1 to FIG. 3. A self-propelled biaxial shearing type crusher 1 (hereinafter, called a crusher 1) of this embodiment is loaded with a biaxial shearing type crushing apparatus 4, which includes a hopper 5 into which objects to be crushed are charged and a crushing section 4A for crushing the charged objects to be crushed at a rear position, on a top portion of a vehicle body frame 3 including a base carrier 2. A power source 6 such as an engine, which is disposed in series with the crushing apparatus 4, is loaded at a front position on the top portion of the vehicle body frame 3. A belt conveyor 7 for transferring crushed objects subjected to crushing processing is provided along an axis line of the vehicle body frame 3 from a position under the crushing apparatus 4 toward the front. The belt conveyor 7 is protruded diagonally upward from a front portion of a vehicle body so as to be able to perform loading into a deck (not shown) of a truck receiving a load from an end portion. A magnetic separator 8 is provided at a front portion of the vehicle body frame 3, across a top portion of the conveyor 7, so that when the crushed objects are nonmetallic materials, metal pieces included in the crushed objects, which are crushed and transferred by the conveyor 7, are selected and taken out to the outside of the conveyor 7.

The operation of the crusher 1 with such a constitution is usually performed by an operator of a material handling machine such as a loader (not shown) for loading the objects to be processed and charging them into the crushing apparatus 4 by a remote control. Alternatively, the operator performs the operation for operating the crusher in the ground section without the directly getting on the crusher 1.

In the crusher 1 of this embodiment, an operation operating panel 10 (hereinafter, called an operating panel 10) for performing an operation for operating a crusher is made capable of being disposed in the vicinity of a cab seat of the material handling machine such as a loader which the operator gets on to perform loading, or at a proper place at an outside portion of the crusher 1. In the operating panel 10, a power receiving part, a base plate, various kinds of switch devices, a transmitter and receiver, and the like are housed in a box in a required size, and a mounting portion capable of being mounted to a machine body to which it is mounted is included, though not shown. A panel surface 11 is provided with various kinds of operating switches for performing an operation for operating the crusher 1, and a monitor 30 for graphically displaying a load condition at the crushing section A of the crushing apparatus 4 in real time. This load condition is obtained by detecting a hydraulic pressure operation condition (for example, a hydraulic pressure change) of a driving section (for example, a hydraulic motor) 4C for driving the crushing section 4A, and arithmetically operating a load at the crushing section 4A when crushing the objects to be crushed based on detection data in a controller 9.

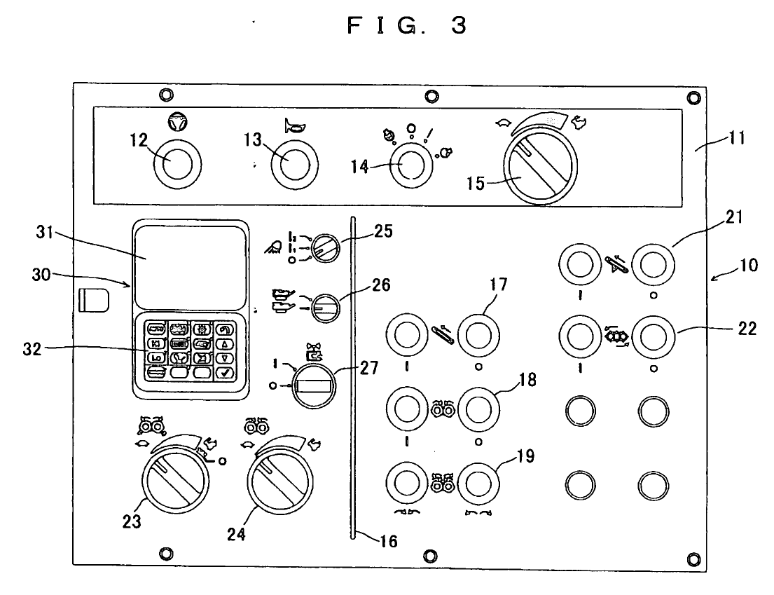

In FIG. 3, on the panel surface 11 of the operating panel 10, an emergency stop button 12, a horn button 13, a key switch 14 and a fuel dial 15 are disposed from the left at an upper side in FIG. 3. On the right side with a vertical line 16 shown in a central portion in FIG. 3 as a border, on/off switch buttons 17 for the belt conveyor 7, automatic operation on/off switch buttons 18 for the crushing apparatus 4, manual operation on/off switch buttons 19 for the crushing apparatus 4 (a crushing rotary body 4b rotates only during time in which it is pressed), which are placed in three tires in an up-and-down direction, are placed in the order from the top. Further, at the right side of them, on/oft switch buttons 21 for a secondary conveyor (not shown). and on/off switch buttons 22 for the magnetic separator are placed. A monitor 30 for displaying setting of operation for operating the crushing apparatus and a load, and an automatic cleaning dial 23 of the crushing section (time selection of reverse rotation for selecting time to perform cleaning, for example, 60 seconds at the maximum), and a crushing speed dial 24 of the crushing section (for selecting a rotational speed) are provided at the left side from the vertical line 16. A light flashing change-over switch 25 during a night operation, a working mode change-over switch 26 (for switching a crushing work and traveling), and a radio control change-over switch 27 (for enabling a remote control operation when it is turned on, and for enabling a panel operation when it is turned off) are disposed, respectively.

In the monitor 30, an upper half part is made a screen 31 by, for example, a liquid crystal or the like, so that the display for operation and a load display are displayed on this portion by switching, and a lower half part is made a touch type display operation switch panel 32 (hereinafter, called the panel 32). The display of the operation procedure necessary for operation, a working mode, a display regarding a load can be switched and shown on the screen 31 by the switch operation.

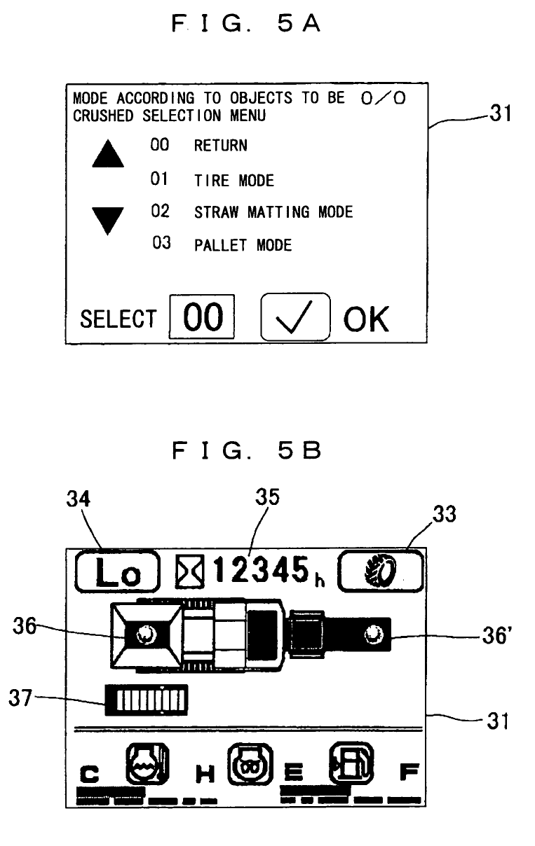

On the screen 31, text screens and graphic screens such as display of selection of the operation conditions operated with the panel 32, and patterns expressing the load conditions, are switched and displayed in accordance with the operation. These are previously set, and the fixed patterns and what shows a change by level display are selectively displayed by the switch operation in accordance with the data controlled in a control unit (see FIG. 5A and FIG. 5B).

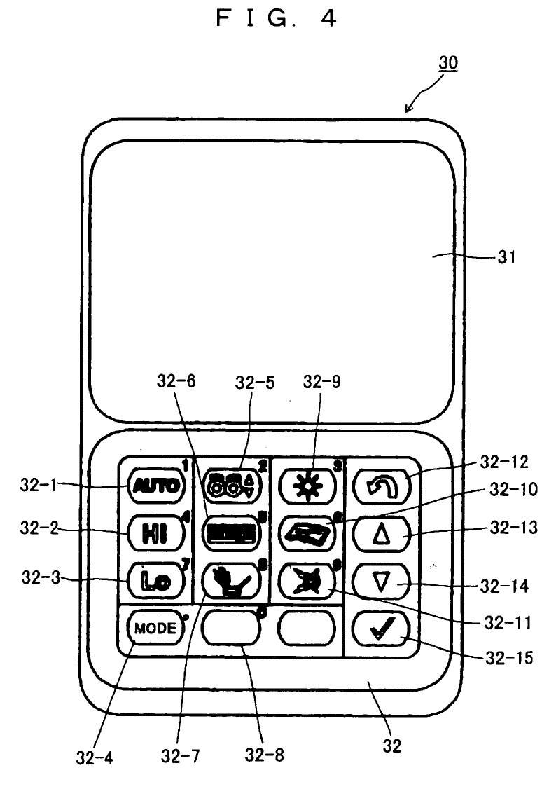

In the screen 31, when switching by a key 32-4 of a mode change-over switch shown in FIG. 4 is performed, the screen becomes the screen in FIG. 5A, and the mode according to the objects to be crushed becomes selectable. When a predetermined mode according to the objects to be crushed is selected, the screen is switched to the screen in FIG. 5B, and the selected object to be crushed (a tire in FIG. 5B) is set to be displayed in a pattern on an enclosed part 33 (mode display part 33) at the upper right of the screen. Rotation setting of the crushing rotary body 4b during operation is shown in an enclosed part 34 (operation condition display part 34) at the upper left in such an expression as “AUTO”, “HI” and “Lo”. Numerals 35 expressed between the mode display part 33 and the operation condition display part 34 indicate the accumulation value of the operating hours. The horizontally long pattern shown at the lower side of them expresses the crusher, and display lamps 36 and 36′ are displayed at a hopper portion and a belt conveyer portion thereof, respectively. When the display changes from green to red, it shows the occurrence of a problem (abnormality) with the red-colored portion. A portion which is rectangular and appears at the lower side of the pattern showing the crusher, with a number of vertical lines being included in it, is a load display part 37.

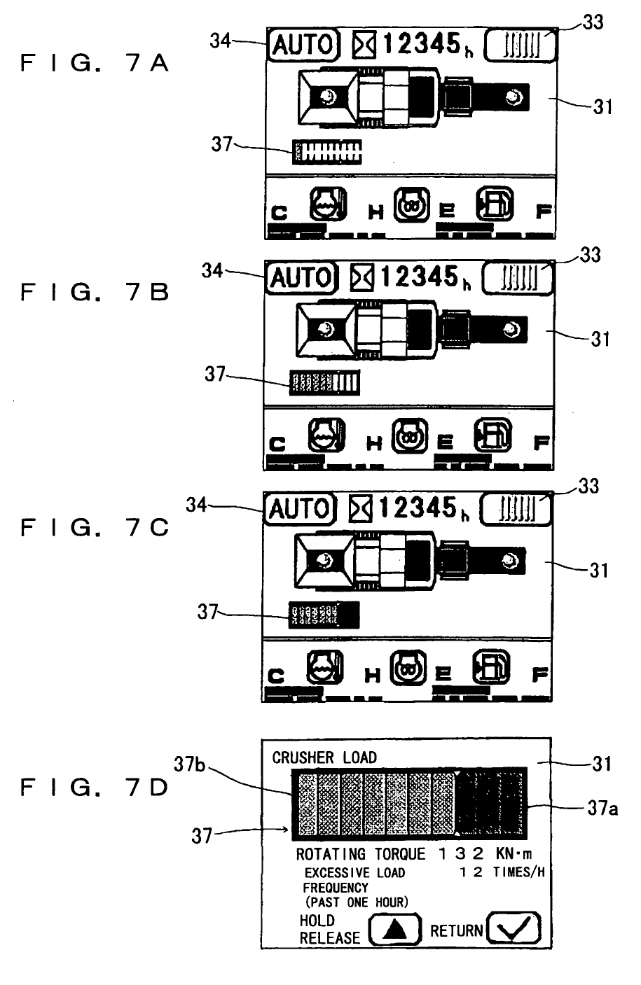

Further, in the load display part 37, the condition of the load exerted on the crushing rotary body 4b in the crushing section 4A is displayed by level within a required time by detecting a change in oil pressure of the driving section 4C and performing arithmetic operation in the controller 9 based on the data. Namely, the rotation torque is measured from the drive pressure of the driving section 4C, and the magnitude of the load (rotation torque) is displayed by level as the maximum torque value as the allowable value (allowable load). The maximum torque value at “HI”, which is the high-speed operation setting, is, for example, 100 KN·m, and the maximum torque value at “Lo”, which is the low-speed operation setting, is, for example, 132 KN·m. The load condition can be displayed by enlarging the load display part 37 by switching the screen as shown in FIG. 7D. The load display part 37 is the display provided with a plurality of divisions made by equally dividing the portion enclosed by a rectangle. In the display part 37, a number of excessive loads display portion 37a, in which the state in that the number of excessive loads (the number of changes in the rotating direction of the crushing rotary body 4b at the time of excessive load) increases sequentially from the right to the left is displayed by level by the change in the colored portion, is provided at the right side, with the line at the position where the small triangular marks are shown up and down at the position spaced by three divisions from the right. The portion with a number of divisions, which is provided at the left side that is opposite thereto is a display portion 37b, which displays a change in load by level by an increase and a decrease of the colored portion, and it can be visually recognized that the load increases when the colored portion increases from the left to the right facing to the line at the aforesaid boarder from the left side. As for the display of the aforesaid number of excessive loads and the display of the load, they may be individually displayed.

As shown in FIG. 4, keys with which the necessary conditions for operating the operation of the crushing apparatus 4 are disposed on the panel 32 with their shares being displayed with pictorial symbols or marks. Nine keys among them are assigned with the functions as numeric keys from 1 to 9. As the numeric keys, the assigned numbers are displayed at the portions at their right shoulders.

Each key on the panel 32 will be explained for each column from the top at the left side in the downward direction. A first key 32-1 is a switch for automatically changing the speed of the crushing rotary body 4b. A second key 32-2 is a switch for performing an operation of switching the rotation of the crushing rotary body 4b to a high speed. A third key 32-3 is used at the time of operation of switching the rotation of the crushing rotary body 4b to a low speed. A fourth key 32-4 is a mode change-over switch, and by pressing this switch, the screen, on which “the mode according to the objects to be crushed selection menu” is displayed as shown in FIG. 5A, is displayed on the screen 31.

A fifth key 32-5 is a reverse rotation time setting screen change-over switch for the crushing rotary body 4b, and with this, the reverse rotation time during which the crushing rotary body 4b is reversely rotated for a required time after it is normally rotated for a required time to make it possible to perform crushing effectively. A sixth key 32-6 is a load display change-over switch with which the load display of the crushing rotary body 4b is switched and displayed, and the details of it will described later.

A seventh key 32-7 is a switch for option, and an eighth key 32-8 is a numeric key which is used for inputting “0”. A ninth key 32-9 is a screen change-over switch for setting contrast and luminance of the liquid crystal screen 31, and when the switch is operated, the screen is switched to the setting screen for the luminance oft the screen and setting screen for the contrast to make it possible to set the screen to be in a desired condition. A tenth key 32-10 is a display switch for a maintenance screen. An eleventh key 32-11 is a buzzer cancel switch.

As for four keys aligned in an up-and down direction at the right side, a twelfth key 32-12 is a switch for a return operation of the screen, a thirteenth key 32-13 and a fourteenth key 32-14 are switches to select a moving direction of a cursor in the upward direction and the downward direction, and a fifteenth key 32-15 is a switch to confirm an operation, from the top in order.

Next, each key operation on the panel 32 and examples displayed on the screen 31 by this will be explained. First, when the mode change-over switch 32-4 is operated on the operation for operating the crushing apparatus, the mode according to the objects to be crushed selection menu is displayed as shown in FIG. 5A. Thus, by operating the numeric key, a desired numeral of a mode, which is displayed in such expression as “01 tire mode”, “02 straw matting mode”, and “03 pallet mode” at the “selection” spot, is entered. In this case, it may be selected by moving the cursor with the key 32-13 and the key 32-14. If “00 return” is entered, the screen is returned to the original state. When any mode is selected, the mode is set by pressing the confirmation key 32-15.

Next, any one of the keys 32-1 to 32-3 is selected and pressed, automatic operation is established with “AUTO”, the high-speed operation is established with “H1”, and the low speed operation is established with “Lo”, as in the display. When the AUTO key 32-1 is selected, the crushing rotary body 4b is normally and reversely rotated at a high speed with a large working amount based on the previously set data to perform a crushing operation. Then, when the load display change-over switch 32-6 is pressed, the screen in FIG. 5B is displayed on the display screen 31.

In this screen, the mode which is selected from the mode according to the objects to be crushed selection mode by being switched by the mode change-over switch 32-4 is “01 tire mode”, and a tire is displayed on the mode display part 33. Since the load acting on the crushing rotary body 4b becomes large because the quality of the object to be processed is a rubber product with tenacity, it is known that the crusher is operated at a low speed with high torque from the display “Lo” at the operation condition display part 34. Namely, the display is constituted so that the operator can confirm the object to be processed and the present working state by pressing the load display change-over switch 32-6.

The load condition at a point of time is displayed by level on the load display part 37, and in the state of FIG. 5B, a small number of colored divisions are displayed on the display portion 37b of the load, and therefore it is instantly determined that this is the state in which operation is performed without a large load being acting thereon. If the display lamps 36 and 36′ distributed to the hopper portion and the conveyor portion are green, it is determined that there is no abnormality. If the level of the display portion 37b of the load becomes high (a large number of colored divisions are displayed), an abnormal event is occurring. Thus, even when the red light is not lit in the display lamps 36 and 36′, the charging amount to the hopper 5 is reduced as the situation requiring a caution, and the drive of the crushing rotary body 4b is adjusted by operating the crushing speed dial 24 to increase speed as necessary, whereby an abnormal operation can be prevented.

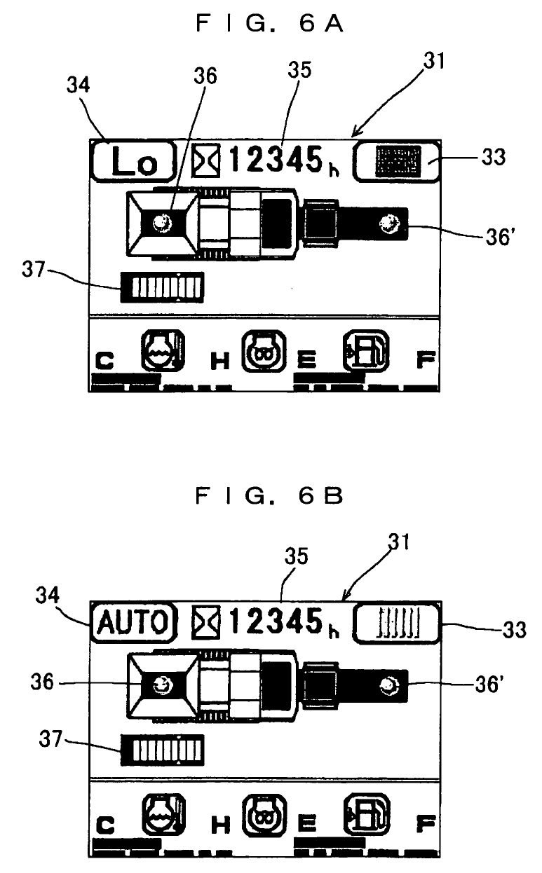

The screen display by mode switching in the load display part 37 will be explained further in detail. When the mode is switched by the mode change-over switch 32-4 to be in “02 straw matting mode”, the pattern of “straw mat” is displayed on the mode display part 33 as shown in FIG. 6A. In this situation, the display of “Lo” indicating a low-speed operation is made on the operation condition display part 34. In the case of “03 pallet mode” by mode switching by the mode change-over switch 32-4, the pattern of the “pallet” is displayed on the mode display part 33 as shown in FIG. 6B, and the display of “AUTO” which indicates an automatic operation is made on the operation condition display part 34. If the selection corresponding to the object to be processed is performed like this, the display corresponding to this is made, and naturally in the crushing apparatus 4, the crushing rotary body 4b is automatically switched to a high speed or a low speed correspondingly and operated in the optimal condition. The display of the aforementioned working modes is not limited to this. For example, the “tire mode” is applied when a soft material, which is easily attached to the crushing rotary body 4b and clogs the clearance of the crushing section 4A due to high tenacity during crushing, as waste rubber products such as a tire is processed. High torque is required in this case, and therefore it is preferable to make low-speed rotation. This is the mode in which it is preferable to make a comparatively large number of reverse rotations.

The “straw matting mode” is for the objects to be processed formed by a material with long fibers as waste straw matting, and is the mode preferable for prevention of tangle by enhancing the frequency of the reverse rotation operation when the long fibers are easily tangled by rotation of the crushing rotary body 4b though the effect of the shearing is generally high. The “pallet mode” is a mode favorable for processing mainly wood products and the like of materials easy to crush such as waste pallets, waste products of wood, and the other house dismantling wastes. It is made possible to easily determine to perform selection of the mode corresponding to each processing condition, and therefore the basic operations can be performed in accordance with this.

To monitor the load condition in the state in which the crushing apparatus is operated in each mode, the load display change-over switch 32-6 of the panel 32 is operated, and thereby the display corresponding to the load condition is shown by level on the load display part 37 in real time as shown in FIG. 7A to FIG. 7D. In FIG. 7A, the working mode in the state of low load is displayed. In the state of FIG.7B, the state in which the load becomes high is displayed. Namely, it is determined from that the colored range of the display level on the display portion 37b of the load reaches the border position. Accordingly, since the operator can instantly recognize that this load level is high, the operator immediately takes the measures corresponding to the load level, whereby the operation can be continued without an occurrence of the abnormal situation.

In the state in FIG. 7C, the load level in the display portion 37b of the load (shown in FIG. 7D) of the load display part 37 becomes the maximum, and when the load of the crushing apparatus 4 becomes a predetermined value or higher, the rotating direction of the crushing apparatus 4 is reversely rotated, and the load of the predetermined value or higher is decreased. This reverse rotation drive may be automatically or manually controlled. The number of the reverse rotations is displayed by level on the number of excessive loads display portion 37a (shown in FIG. 7D) of the load display part 37, and therefore it can be recognized that the number of excessive loads (the number of reverse rotations) reaches the maximum. When the number of excessive loads display portion 37a reaches the maximum level (three times in FIG. 7D) in a predetermined time (for example, 13 seconds), the crushing apparatus 4 is stopped (may be automatically stopped), and checked, and remedial measures are taken immediately to return to normality, whereby stop of operation can be avoided. Thus, the operator can instantly understand the working condition on the operating panel 10 placed near the operator, and copes with the situation quickly to make it possible to continue operation.

In order to clarify the display more on the load display part 37, enlarged display can be made by switching the screen. FIG. 7D shows the situation of the aforesaid maximum load, and the state, in which the display portion 37b of the load and the number of excessive loads display portion 37a display the maximum, can be clearly recognized.

The rotation torque by the present load is displayed by the numeral vale in real time under the load display part 37. Further, the accumulated excessive load frequency (the number of reverse rotations) within the past one hour is displayed. Since reduction in the number of excessive loads enhances the working efficiency, the display of the accumulated excessive load frequency is very useful in detection of whether the way of the working (the charging amount of the object to be crushed or the like) of the past one hour is appropriate. The accumulation time may be a predetermined time instead of one hour.

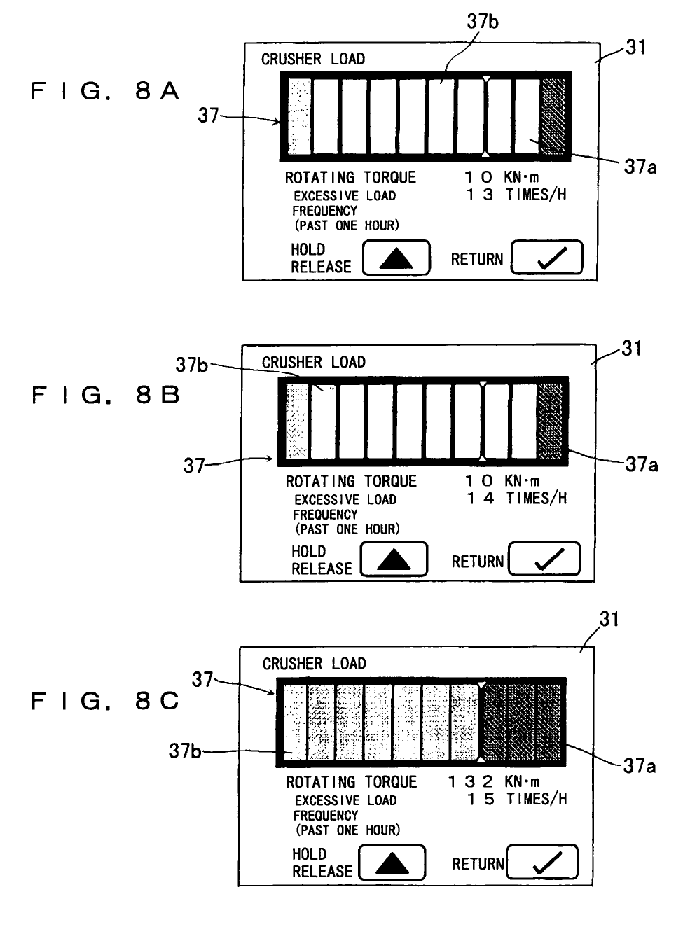

FIG. 8A to FIG. 8C show modes of display of the number of excessive loads, the state in FIG. 8A shows the situation in which the change of the rotating direction of the crushing rotary body in the excessive load state is once, the state in FIG. 8B shows the situation in which the change of the rotating direction of the crushing rotary body is twice, and further, the state in FIG. 8C shows the situation in which the change of the rotating direction of the crushing rotary body is three times and the load becomes the maximum. By enlarged display of the load display part 37, the load condition can be confirmed more clearly, and the working condition can be easily grasped by utilizing the limited area of the screen.

If the operating panel including the load display device of this embodiment is provided at a specific location (for example, in the vicinity of the cab seat of the loader) by making it possible to perform transfer of the data by wire or wireless, one operator can properly perform a charging operation of objects to be processed and an operation for operating the crusher at the same time. In addition, a skilled operator can enhance the workability without performing the processing work while keeping the state of strain as in the prior art. Meanwhile, even an operator insufficient in skill easily grasps the load condition, and therefore, the operator can perform a smooth operation without strain. Further, if the operating panel is made a portable type, the operation of the crusher can be performed while the load state is confirmed at a location away from the crusher in the ground section. It is naturally possible to use the operating panel by being mounted to the proper spot of the outer portion of the crusher.

In the above explanation, the case in which the present invention is used for the self-propelled biaxial shearing type crusher is described, but any crusher, which includes the apparatus for performing control processing by a controller by receiving the change data of the hydraulic pressure in the driving section of the crushing apparatus, may be used as the example utilizing the present invention.

Accordingly, it goes without saying that the present invention can be also applied to an impact crusher, a jaw crusher and the other types of crushers.

What is claimed is:

1. A load display device for a crusher for displaying a load condition at a crushing section in the crusher, comprising:
a monitor provided at a location which an operator is able to recognize visually; and
a screen which is provided on said monitor and graphically displays a condition of a load at said crushing section.

2. The load display device for the crusher according to claim 1,
wherein a frequency of excessive load within a predetermined time at said crushing section and a number of changes of a rotating direction of said crushing section within a predetermined time are displayed as additional load display.

3. The load display device for the crusher according to claim 1,
wherein load display is made corresponding to a selected object to be processed, on a load display part of said screen.

4. The load display device for the crusher according to claim 3,
wherein a frequency of excessive load within a predetermined time at said crushing section and a number of changes of a rotating direction of said crushing section within a predetermined time are displayed as additional load display.

5. The load display device for the crusher according to claim 1,
wherein load display made on said screen is level display which relates to magnitude of the load at a driving section for driving said crushing section, and is made with an allowable load as a maximum.

6. The load display device for the crusher according to claim 5,
wherein a frequency of excessive load within a predetermined time at said crushing section and a number of changes of a rotating direction of said crushing section within a predetermined time are displayed as additional load display.

7. The load display device for the crusher according to claim 5,
wherein said level display is made corresponding to a selected object to be processed.

8. The load display device for the crusher according to claim 7,
wherein a frequency of excessive load within a predetermined time at said crushing section and a number of changes of a rotating direction of said crushing section within a predetermined time are displayed as additional load display.
